(19) United States
(12) Patent Application Publication
(10) Pub. No.: US 2018/0216017 A1
(43) Pub. Date: Aug. 2, 2018

(54) SYSTEM AND METHOD UTILIZING A MECHANISTIC, PHYSICS-BASED DYNAMIC DESALTER MODEL

(71) Applicant: GENERAL ELECTRIC COMPANY, Schenectady, NY (US)

(72) Inventors: Aditya KUMAR, Schenectady, NY (US); Michael Alan DION, The Woodlands, TX (US); Nimeshkumar Kantilal PATEL, The Woodlands, TX (US); Conrad Keny TERAN, The Woodlands, TX (US); Dan DAI, Niskayuna, NY (US); Randall Charles MCFARLANE, Loudonville, NY (US); Sree Rama Raju VETUKURI, Philadelphia, PA (US); Vijaysai PRASAD, Bangalore (IN)

(21) Appl. No.: 15/754,413

(22) PCT Filed: Aug. 1, 2016
(86) PCT No.: PCT/US2016/045024

§ 371 Date: Feb. 22, 2018

Related U.S. Application Data
(60) Provisional application No. 62/199,441, filed on Jul. 31, 2015.

(51) Int. Cl. C10G 31/08; G05B 15/02

(52) U.S. Cl. CPC C10G 31/08; C10G 2300/205; G05B 15/02

(57) ABSTRACT

According to some embodiments, data associated with the operation of a desalter vessel (150), adapted to receive a raw crude input and a water input and facilitate creation of a desalted crude output and a salt water output, may be stored in a computer storage device (630). A computer processor (610) may determine at least one parameter associated with the data in the computer store. The computer processor (610) may then automatically calculate, based on the determined parameter and a physics-based dynamic desalter model (400), an adjustment value for a second parameter associated with operation of the desalter vessel. Using the automatically calculated adjustment value, the computer processor (610) may automatically generate and transmit an indication of the adjustment value so as to improve operation of the desalter vessel (150).

### BACKGROUND

Desalting is typically the first operation in oil refineries. Crude oil that is processed without desalting may be detrimental to the refinery assets, leading to severe corrosion problems. The desalter system removes the majority of salts in the crude oil by injecting water into the system. Because of the higher solubility in water, salts move from the crude oil to the water phase. Thus, desalter systems are typically large gravity settling tanks that provide enough residence time for both the water and the crude oil to settle. Usually density of water is higher than that of oil; hence, water settles at the bottom of the desalter system, and crude oil leaves the unit from the top. Further, the addition of an electrical grid at the top of desalter systems may promote the separation of crude oil at the top and the water to settle at the bottom.

In some cases, the crude oil and water may have a relatively thin interface. However, in practice, during the operation, an emulsion of water in crude oil may be formed as a distinct layer between the water and crude oil. This emulsion band, also referred to as a “rag layer,” can be quite dynamic in position and size. Typically, these emulsion bands can cause oil refiners to run less than optimum wash water rates and low mix valve pressure drops, which reduces its efficiency for salt and sediment removal. Excessive growth of these emulsion bands can shorten the operational lifespan of the electrical grids in the desalter system, thus bringing the entire refinery operations to a halt. Accordingly, it may be important to monitor and control the performance of the desalter system and keep the position and size of the emulsion band under control.

Performance of the desalter may be characterized, for example, based on: percentage salt removal in desalted crude oil relative to that of feed, percentage water removal in desalted crude oil relative to that of feed, and/or percentage oil carry over in brine or desalter water exit stream. Optimal operation of the desalter means very high values of salt and water removal and close to zero value for oil carryover in water. Adjustments may be made during operation of the desalter to improve performance.

Note that efficient operation of the desalter system may be difficult and require an expert with substantial experience to make the right corrective adjustments. The crude oil blend in refineries changes frequently, and when the refineries process a new blend, the operators need to be able to judge performance of the desalter system without direct visibility of the emulsion band (rag layer), to determine effectiveness of the chemical treatment, and to initiate appropriate corrective actions during upset conditions.

Thus, there exists a strong need for a method of providing advisory data for a desalter system, which may continuously monitor performance of the desalter system, continuously monitor a position of the emulsion band, control the emulsion band using chemicals and/or provide appropriate recommendations for maintaining improved pressure drop at the mix valve.

Therefore, it would be desirable to design an apparatus and method that facilitates generation of appropriate advisory data for a desalter system.

### BRIEF DESCRIPTION

According to some embodiments, data associated with the operation of a desalter vessel, adapted to receive a raw crude input and a water input and facilitate creation of a desalted crude output and a salt water output, may be stored in a computer storage device. A computer processor may determine at least one parameter associated with the data in the computer storage device. The computer processor may then automatically calculate, based on the determined parameter and a physics-based dynamic desalter model, an adjustment value for a second parameter associated with operation of the desalter vessel. Using the automatically calculated adjustment value, the computer processor may automatically generate and transmit an indication of the adjustment value so as to improve operation of the desalter vessel.

Some embodiments provide: means for means for storing, in a computer storage device, data associated with the operation of a desalter vessel adapted to receive a raw crude input and a water input and facilitate creation of a desalted crude output and a salt water output; means for determining, by a computer processor, at least one parameter associated with the data in the computer storage device; means for automatically calculating by the computer processor, based on the determined parameter and a physics-based dynamic desalter model, an adjustment value for a second parameter associated with operation of the desalter vessel; and means for using the automatically calculated adjustment value, automatically generating and transmitting, by the computer processor, an indication of the adjustment value so as to improve operation of the desalter vessel.

Other embodiments are associated with systems and/or computer-readable medium storing instructions to perform any of the methods described herein.

### DRAWINGS

FIG. 1 is a block schematic diagram of a desalter system in accordance with some embodiments.

FIG. 2 illustrates a method according to some embodiments.

FIG. 3 illustrates the inner operation of a desalter vessel in accordance with some embodiments.

FIG. 4 is a high level architecture for a mechanistic, physics-based desalter model according to some embodiments.

FIG. 5 is a block diagram of a control system in accordance with some embodiments.

FIG. 6 is block diagram of a desalter tool or platform according to some embodiments of the present invention.

FIG. 7 is a tabular portion of a desalter input database according to some embodiments.

FIG. 8 illustrates a user display for a desalter system in accordance with some embodiments.

### DETAILED DESCRIPTION

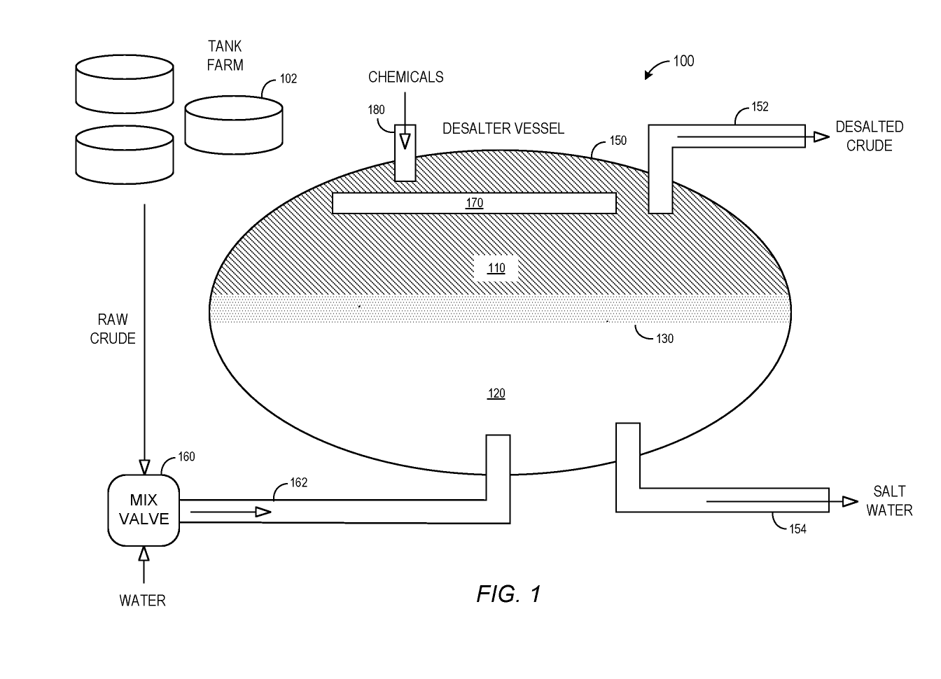

FIG. 1 is a block schematic diagram of a desalter system 100 in accordance with some embodiments. The system includes a desalter vessel 150 that receives a combination of raw crude oil (e.g., from a tank farm 102) and water from a mix valve 160 via an input pipe 162. The desalter vessel 150 provides desalted crude oil via a first output pipe 152 and salt water or brine via a second output pipe 154. A chemical input pipe 180 and/or an electrified grid 170 may facilitate separation within the desalter vessel 150 of an oil region 110 and a water region 120 that interface at a rag layer 130. The geometry of the vessel 150 and associated pipes 162, 152, 154, 180, the chemicals injected into the vessel, the power applied to the electrified grid may all impact operation of the system.

Moreover, variation in crude oil composition and properties may cause operational issues with the system 100, which in turn may impact downstream operation and reliability of a refinery. Note that many different factors, both physical and chemical, may interact to govern the desalter vessel 150 behavior in the presence of crude variations. These factors, and their interaction, are complex and may result in a limited ability to achieve robust and consistent operation of the system. Typically, a desalter vessel 150 is one of the least instrumented and automated units in a refinery. Experienced operators manually make operational decisions based on limited information and limited knowledge of the overall desalter operation. Embodiments described herein may facilitate an automatic generation of appropriate advisory data to improve performance of the desalter system 100.

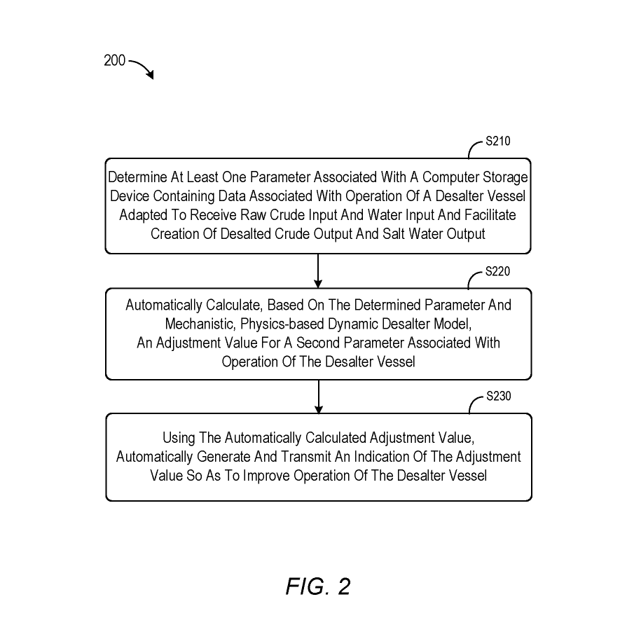

For example, FIG. 2 is a flow chart of a method 200 in accordance with some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, at least one parameter within a computer storage device, such as a computer store, may be “automatically” determined. As used herein, a process may be “automatic” if it can be performed with little or no human intervention. The computer storage device may, for example, contain data associated with the operation of a desalter vessel adapted to receive a raw crude input and a water input and facilitate creation of a desalted crude output and a salt water output. The determined parameter might be associated with one or more of: (i) a temperature, (ii) a pressure, (iii) an amount of water in the desalted crude output, (iv) an amount of salt in the desalted crude output, and/or (v) an amount of crude in the salt water output. The determined parameter might also be associated with at least one of: (i) an electric grid, (ii) a density, (iii) a viscosity, (iv) emulsion characteristics, (v) an inflow rate, (vi) an outflow rate, and/or (vii) a rag emulsion layer.

According to some embodiments, the determined parameter is associated with an amount of a chemical, an Emulsion Breaker (“EB”), and/or a Reverse Emulsion Breaker (“REB”). Note that the adjustment value might be associated with a chemical, an electric grid, an inflow rate, and/or an outflow rate. By ways examples only, the chemical might be associated with a demulsifier chemical such as oxyalkylated amines, alkylaryl sulfonic acid and salts thereof, oxyalkylated phenolic resins, polymeric amines, glycol resin esters, polyoxyalkylated glycol esters, fatty acid esters, oxyalkylated polyols, low molecular weight oxyalkylated resins, bisphenol glycol ethers and esters, and/or polyoxyalkylene glycols.

At S220, the system may calculate, based on the determined parameter and a physics-based dynamic desalter model, an adjustment value for a second parameter associated with operation of the desalter vessel. According to some embodiments, the calculation of S220 is performed automatically. At S230, the system may use the automatically calculated adjustment value to automatically generate and transmit an indication of the adjustment value so as to improve operation of the desalter vessel. Note that the mechanistic, physics-based dynamic desalter model might incorporate physical properties of the crude oil mixture feeding the unit, wash water and any recycle fluids, including slop, geometry of desalter vessel, water droplet size, water droplet distribution, crude oil droplet size, crude oil droplet distribution, droplet coalescence, hydrodynamics, settled solids, a rag emulsion layer, and/or a mixing valve model.

In some embodiments, the mechanistic, physics-based dynamic desalter mode may include a basic model with coalescence abilities that have been validated with batch separation literature data. Moreover, the model may have augmented capabilities, such as improved electro-coalescence, series configuration, multiple phases in electric grids, dual port mixing valve, salt, filterable solids, asphaltene precipitation, and/or mud wash consideration. Further, the model may take into account physical properties and composition of the crude oil feed to the unit and chemical additions designed to enhance the demulsification processes occurring in the desalter

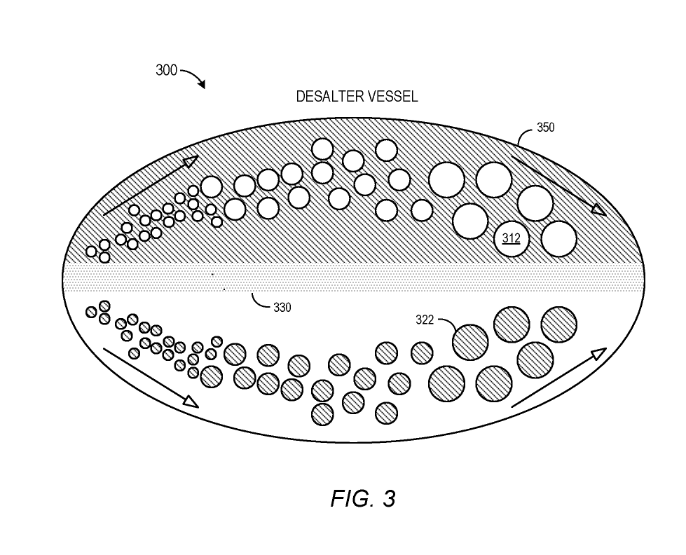

FIG. 3 illustrates the inner operation of a desalter vessel 300 in accordance with some embodiments. The desalter vessel 300 includes an oil region having some water droplets 312 (shown white in FIG. 3) and a water region having some oil droplets 322 (shown crosshatched in FIG. 3). Note that the average size of the droplets 312, 322 might increase over time, causing them to migrate (fall or rise) to the rag layer 330. Some inputs associated with the operation of the desalter vessel 300 include desalter design geometry and configuration, oil-water mixture in feed (% water), in/out flow rates—residence times, water droplet size distribution in feed and desalter, coalescence of droplets (both general and electro), hydrodynamics—internal oil/water flows, phase inversion, and/or solids settling (reduced residence time). a (these are all mentioned in 26)

additional inputs/factors may include emulsion (rag) formation and stability, impact on separation, the effect of crude properties, the effect of water properties, and/or the effect of chemicals (EB, REB). Some outputs associated with the operation of the desalter vessel 300 include amount oil in brine, water, salt and solids in desalted oil, oil/water profile along desalter height, rag layer location and width, and/or transient dynamics—residence time.

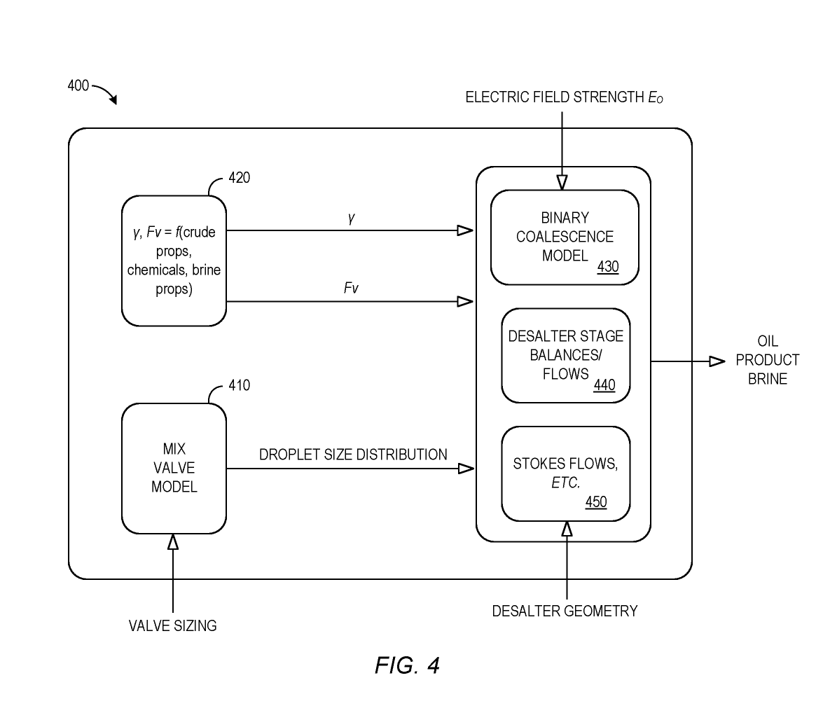

FIG. 4 is a high level architecture for a mechanistic, physics-based desalter model 400 according to some embodiments. The model 400 includes a mix valve model 410 that receives valve sizing data and a function ƒ 420 that takes into account crude oil properties, chemicals, and brine water properties. The model 400 may further receive the following inputs:
F_{feed+water}
μₒᵢₗ
ρₒᵢₗ
ρ_{water}

According to some embodiments, the model 400 also includes a binary coalescence model 430, desalter stage balances and flows 440, and a Stokes flow component 450 to generate predicted oil product and brine output based on an electric field strength E_{O} and desalter geometry. Note that a net coalescence rate for droplets might be represented by a collision frequency multiplied by a collision efficiency for the droplets. Moreover, the rate may comprise a function f (desalter conditions, electric field, emulsion droplet size distribution, crude properties and composition, water properties, chemical demulsifier type and concentration). As a result, smaller droplets may disappear (due to coalescence to larger ones). With respect to the binary coalescence model 430, a dynamic volume of balance on a bubble k in section i of a desalter vessel might be represented as follows:

$${V}_{i} \frac{{dx}_{W , i}^{k}}{dt} = {F}_{fi} {x}_{FW}^{k} + {f}_{W , i + 1}^{k} - {f}_{W , i}^{k} [ - {F}_{B} {x}_{W , 1}^{k} ] + ( 1 - {β}_{i} ) {R}_{CW , i}^{k}$$

Some embodiments described herein may use first principles to capture important cause and effect relationships to build a dynamic model 400 of a refinery desalter, which can predict both steady-state and dynamic behavior. The model 400 may capture effects of crude and water properties, chemical dosage and type, desalter operating conditions, including upstream mixing valve, electro- and general-coalescence, and/or hydrodynamic data for oil-water separation within a vessel. The model 400 may predict behavior of an oil-water profile along vessel height, oil/water droplet size distribution, water level, rag/emulsion location and size inside the vessel, solids balance and accumulation, and/or asphaltene precipitation and accumulation. It may also provide values for key performance indicators associated with product streams, both the desalted crude and the effluent brine, giving the oil/water content, salt content/removal, solids content and asphaltene content. The model 400 might be configured for different types of commercial and pilot-scale desalters for both single and multi-stage with different flow configurations of raw, recycled crude, fresh and recycled wash water, mud wash, etc. The model 400 may also be configured for bench-scale experimental setups.

The model 400 might be used as a basis for offline troubleshooting, what-if scenario simulations, selection of crude oils or crude oil blends for feeding to the refinery, model-based estimation of key performance indicators, advisory controls for chemical dosing and operating conditions. According to some embodiments, the model 400 may be used for model-based control and optimization of a desalter. The model 400 may also be used for online detection and diagnosis of abnormal conditions and faults as well as to optimize design of a desalter unit.

The mechanistic, physics-based model 400 with fundamental differential and algebraic equations may describe key cause and effect relationships and their interaction to describe the overall steady-state/dynamic input/output behavior. The physics-based model 400 may be coupled with an empirical model for the effect of key crude oil and chemicals properties on the coalescence and settling processes occurring in the desalter. The model 400 may have one or more adjustable parameters for each cause-effect relationship that can be fine-tuned based on operation data to improve site-specific accuracy and adaptation over time. The model 400 may be implemented as a computer program to efficiently calculate the dynamic and steady-state behavior, and predict key performance indicators (such as level, rag/emulsion layer location and height, and desalted crude/brine properties)) as one or more inputs are varied.

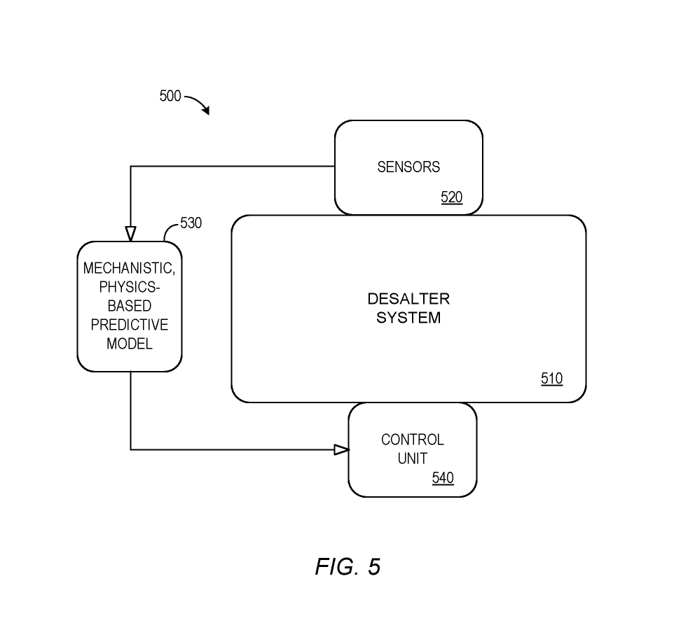

FIG. 5 is a block diagram of a control system 500 in accordance with some embodiments. The system 500 includes a desalter system 510 monitored by one or more sensors 520. Data from the sensors 520 is fed to a mechanistic, physics-based predictive model 530 when analyzes the data and provides an output to a control unit 540 to improve operation of the desalter system 510 in substantially real time. According to some embodiments, the system 100 may be associated with a multi-stage crude oil refinement process having a plurality of desalter vessels. Note that the model 530 may be used in a nonlinear model-based multivariable control algorithm to initially automate the control of chemical dosing, and provide advisory control for other control inputs (e.g. mix valve, flow rates, electric grid). A model-based diagnostics solution may be developed using a combination of model-based estimation algorithms, hypothesis testing and pattern matching to detect and isolate faults like sensor faults from abnormal conditions in the crude and/or the desalter system 540. According to some embodiments, the automatically calculated adjustment value is associated with a dual ported mix value for the desalter vessel. Moreover, the mechanistic, physics-based dynamic desalter model 530 might comprises a predictive model that accounts for non-ideal crude oil and water properties and emulsion characteristics.

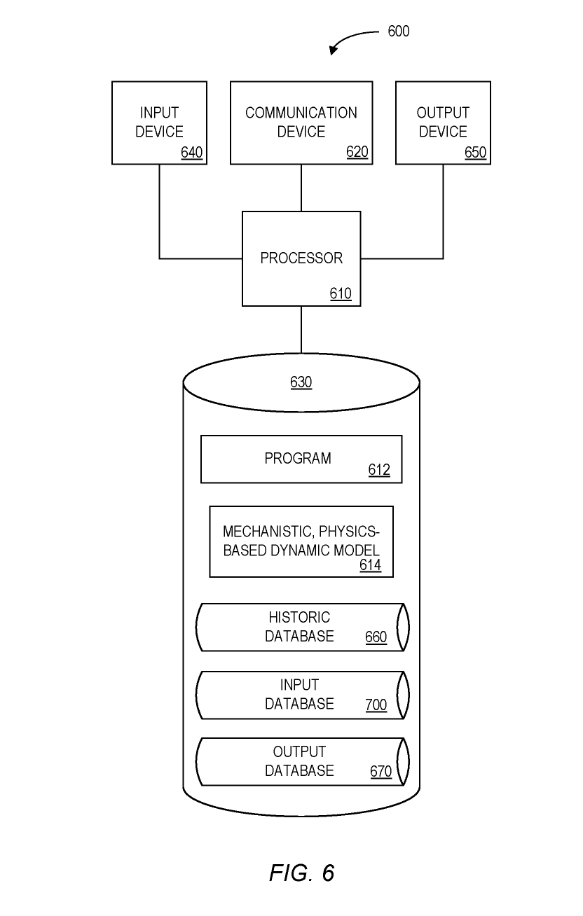

The embodiments described herein may be implemented using any number of different hardware configurations. For example, FIG. 6 illustrates a desalter platform 600 that may be, for example, associated with the system 100 of FIG. 1A. The desalter platform 600 comprises a processor 610, such as one or more commercially available Central Processing Units (CPUs) in the form of one-chip microprocessors, coupled to a communication device 620 configured to communicate via a communication network (not shown in FIG. 6). The communication device 620 may be used to communicate, for example, with one or more remote requestor devices and/or weather reporting services. The desalter platform 600 further includes an input device 640 (e.g., a mouse and/or keyboard to enter information about model algorithms) and an output device 650 (e.g., to output reports regarding desalting operations).

The processor 610 also communicates with a storage device 630. The storage device 630 may comprise any appropriate information storage device, including combinations of magnetic storage devices (e.g., a hard disk drive), optical storage devices, mobile telephones, and/or semiconductor memory devices. The storage device 630 stores a program 612 and/or a desalting model or application 614 for controlling the processor 610. The processor 610 performs instructions of the programs 612, 614, and thereby operates in accordance with any of the embodiments described herein. For example, the processor 610 may receive data associated with the operation of a desalter vessel, adapted to receive a raw crude input and a water input and facilitate creation of a desalted crude output and a salt water output. The processor 610 may automatically determine at least one parameter within the computer store. The processor 610 may then automatically calculate, based on the determined parameter and a physics-based dynamic desalter model, an adjustment value for a second parameter associated with operation of the desalter vessel. Using the automatically calculated adjustment value, the processor may automatically generate and transmit an indication of the adjustment value (e.g., via the communication device 620) so as to improve operation of the desalter vessel.

The programs 612, 614 may be stored in a compressed, uncompiled and/or encrypted format. The programs 612, 614 may furthermore include other program elements, such as an operating system, a database management system, and/or device drivers used by the processor 610 to interface with peripheral devices.

As used herein, information may be “received” by or “transmitted” to, for example: (i) the desalter platform 600 from another device; or (ii) a software application or module within the desalter platform 600 from another software application, module, or any other source.

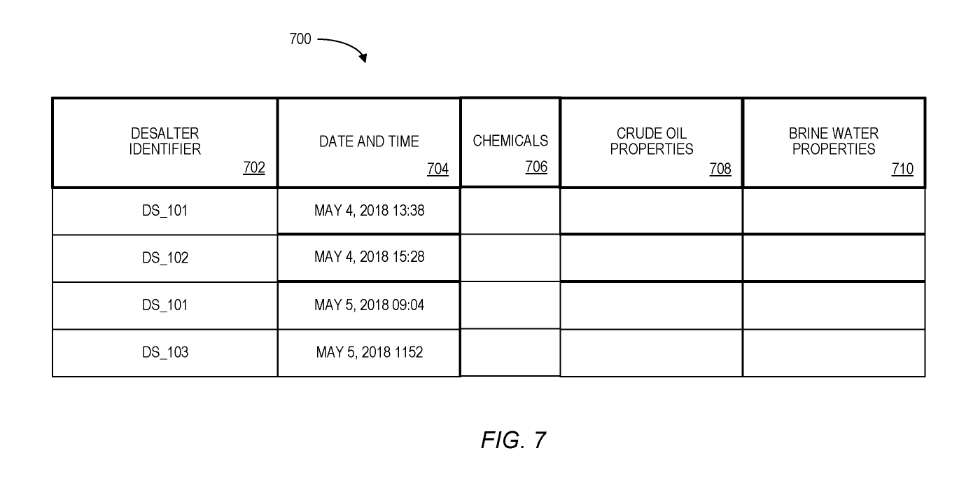

In some embodiments (such as shown in FIG. 6), the storage device 630 includes a historic database 660 (e.g., associated with past desalting operations, results, etc.), an input database 700 (e.g., indicating desalting geometries, settings, etc.) and an output database 670. An example of a database that may be used in connection with the desalter platform 600 will now be described in detail with respect to FIG. 7. Note that the database described herein is only one example, and additional and/or different information may be stored therein. Moreover, various databases might be split or combined in accordance with any of the embodiments described herein. For example, the historic database 660 and/or input database 700 might be combined and/or linked to each other within the dynamic model 614.

Referring to FIG. 7, a table is shown that represents the input database 700 that may be stored at the desalter platform 600 according to some embodiments. The table may include, for example, entries identifying operations of desalter systems. The table may also define fields 702, 704, 706, 708, 710 for each of the entries. The fields 702, 704, 706, 708, 710 may, according to some embodiments, specify: a desalter system identifier 702, a date and time 704, chemicals 706, crude oil properties 708, and brine water properties 710. The input database 700 may be created and updated, for example, based on information electrically received sensors attached to pipelines, etc.

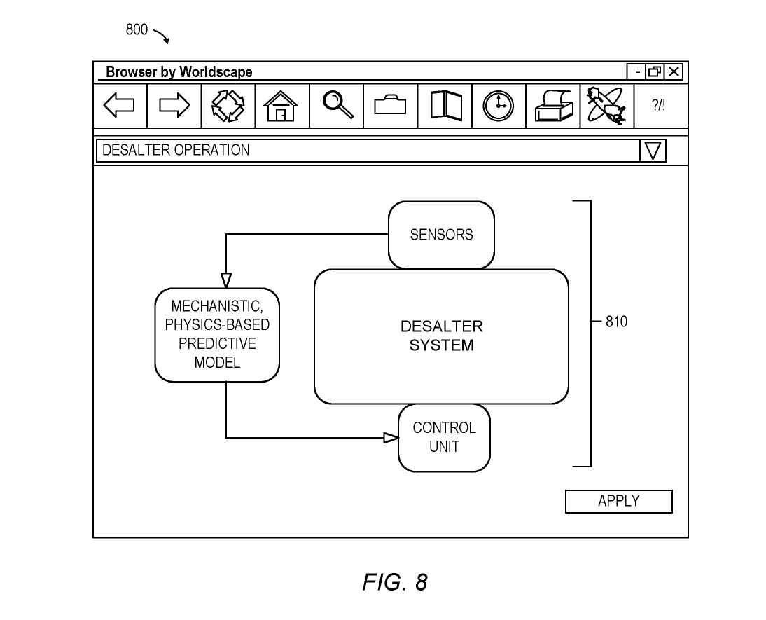

The desalter system identifier 702 may be, for example, a unique alphanumeric code associated with a desalter vessel. Note that another database might store information about the pipes, geometries, etc. of that desalter vessel. The date and time may 704 indicate when the desalting process occurred. The chemicals 706, crude oil properties 708, and brine water properties 710 may be used by a model to improve operation of a desalter vessel. For example, recommended adjustments may be output via a user display 800 for a desalter system such as the one illustrated in FIG. 8 in accordance with some embodiments. The display 800 might include, according to some embodiments graphical 810 and/or numerical indications of how operation of a desalter should be adjusted to improve the performance of the system.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

For example, embodiments described herein might be associated with a multi-drum treatment process. In some cases, a dynamic desalter model has the ability to estimate state of the oil-in-water as well as water-in-oil emulsion across the oil-water interface. Resolving these two types of emulsions may require ys on each of the phases separately, which the desalter model exclusively provides. Chemical treatment for desalters in refinery is typically done with single drum product which has certain fixed percentage of chemicals relevant for each type of emulsions. On the other hand, dynamic desalter model guides multi-drum treatment solution, by which the treatment can be adjusted in-situ by varying percentage of chemicals needed to resolve oil in water and water in oil emulsion separately.

Moreover, some embodiments might be associated with a location to add chemicals for a series configuration. Note that the addition of certain specific functionality chemicals such as corrosion inhibitors, scale inhibitors etc. into the desalter might interfere with the oil-in-water demulsification process. When two desalters are in series, the desalter model might allow the user to carry-out “what-if” analysis on where to dose which chemical (either to the first or the second desalter). The model hence may allow the user to also optimize dosage while providing direction to the right dosage location. Some embodiments may also help optimize the treatment when both water and oil based demulsifiers are used thereby allowing operators to choose the location and point of addition in the case of series configuration.

Some embodiments might be associated with a prediction of chemical concentration at an interface. Although the residence time for oil and water in a desalter is broadly defined, it is to be noted that each element of oil or water spend different time in desalter depending on its position. The residence time of elements at the interface specifically is much larger than the elements. The desalter model hence may allow a user to estimate concentration of chemicals and the charge potential at the interface which plays a major role in stabilizing/destabilizing emulsions at the interface.

According to some embodiments, desalting water quantities may be adjusted. For example, a framework might continuously monitor the BS&W and slug-water carryover through a pipeline with additional sensors. Depending on the water level in the incoming crude, the DDT may recommend that the operator cut back on the amount of water being added for demulsification. Similarly, slop oil addition might be recommended. For example, additional dosage demand to process specific volume and quality of slop oil may be measured and/or recommended to the user.

Note that ETP upsets are very common in refineries processing tougher oils. Most often, this is due to the desalter water carrying several organics that have inhibitory or biocidal nature. Predicting seepage of such organics may help the ETP operators subject this water to additional treatment that would be necessary only on need basis. The CrudePLUS primarily predicts possible deterioration in the brinewater quality and helps the ETP operators to adjust treatment proactively.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system useful in a crude oil refinement process, the system comprising:
a computer storage device containing data associated with operation of a desalter vessel adapted to receive a raw crude input and a water input and facilitate creation of a desalted crude output and a salt water output; and
a computer processor coupled to the computer storage device and programmed to:
determine at least one parameter associated with the data in the computer storage device,
automatically calculate, based on the determined parameter and a mechanistic, physics-based dynamic desalter model, an adjustment value for a second parameter associated with operation of the desalter vessel, and
using the automatically calculated adjustment value, automatically generate and transmit an indication of the adjustment value so as to improve operation of the desalter vessel.

2. The system of claim 1, wherein the determined parameter is associated with at least one of: (i) a temperature, (ii) a pressure, (iii) an amount of water in the desalted crude output, (iv) an amount of salt in the desalted crude output, and (v) an amount of crude in the salt water output.

3. The system of claim 1, wherein the determined parameter is associated with at least one of: (i) an electric grid 170, (ii) a density, (iii) a viscosity, (iv) emulsion characteristics, (v) an inflow rate, (vi) an outflow rate, and (vii) a rag emulsion layer.

4. The system of claim 1, wherein the determined parameter is associated with at least one of: (i) an amount of a chemical, (ii) an emulsion breaker, and (iii) a reverse emulsion breaker.

5. The system of claim 1, wherein the adjustment value is associated with at least one of: (i) a chemical, (ii) an electric grid 170, (iii) an inflow rate, and (iv) an outflow rate.

6. The system of claim 5, wherein the adjustment value is associated with a demulsifier chemical comprising at least one of: (i) oxyalkylated amines, (ii) alkylaryl sulfonic acid and salts thereof, (iii) oxyalkylated phenolic resins, (iv) polymeric amines, (v) glycol resin esters, (vi) polyoxyalkylated glycol esters, (vii) fatty acid esters, (viii) oxyalkylated polyols, (ix) low molecular weight oxyalkylated resins, (x) bisphenol glycol ethers and esters, and (xi) polyoxyalkylene glycols.

7. The system of claim 1, wherein the mechanistic, physics-based dynamic desalter model incorporates at least one of: (i) i physical properties associated with the crude feed to the desalter unit, and chemicals, (ii) a geometry of desalter vessel, (iii) water droplet size, (iv) water droplet distribution, (v) crude oil droplet size, (vi) crude oil droplet distribution, (vii) droplet coalescence, (viii) hydrodynamics, (ix) settled solids, (x) a rag emulsion layer, and (xi) a mixing valve model.

8. The system of claim 1, wherein the system is associated with a multi-stage crude oil refinement process having a plurality of desalter vessels.

9. The system of claim 1, wherein the automatically calculated adjustment value is associated with a dual ported mix value for the desalter vessel.

10. The system of claim 1, wherein the mechanistic, physics-based dynamic desalter model comprises a predictive model that accounts for the effect of crude oil and water properties, chemicals properties and dosages and emulsion characteristics on the performance of the desalter vessel.

11. The system of claim 1, wherein the mechanistic, physics-based dynamic desalter model is associated with at least one of: (i) an offline troubleshooting application, (ii) a what-if scenario simulation, (iii) a selection tool of crude oils or crude oil blends for feeding to a refinery, (iv) an estimation of key performance indicators, (v) advisory controls for chemical dosing and operating conditions, (vi) a troubleshooting application, (vii) fault detection logic, and (viii) a multi-desalter vessel implementation.

12. A system useful in a crude oil refinement process, the system comprising:
a plurality of sensors collecting data associated with operation of a desalter vessel adapted to receive a raw crude input and a water input and facilitate creation of a desalted crude output and a salt water output;
a computer processor coupled to a computer store and programmed to:
automatically determine at least one parameter within the computer store,
automatically calculate, based on the determined parameter and a mechanistic, physics-based dynamic desalter model, an adjustment value for a second parameter associated with operation of the desalter vessel, and
using the automatically calculated adjustment value, automatically generate and transmit an indication of the adjustment value in substantially real time; and
at least one control unit to receive the adjustment value and automatically improve operation of the desalter vessel.
